(19) United States
(12) Patent Application Publication
(10) Pub. No.: US 2008/0298627 A1
(43) Pub. Date: Dec. 4, 2008

(54) WATER RESISTANT AUDIO MODULE

(75) Inventors: Ron Bonebright, Lincoln, NE (US); Abhinav Srivastava, Pittsburgh, PA (US); Jim Stratman, Omaha, NE (US)

Correspondence Address: HOLLAND & HART, LLP, P.O BOX 8749, DENVER, CO, 80201, US

(73) Assignee: Laird Technologies, Inc., Lincoln, NE (US)

(21) Appl. No.: 11/756,377

(22) Filed: May 31, 2007

(51) Int. Cl. H04R 1/02; H04M 1/00

(52) U.S. Cl. 381/386; 381/124; 455/550.1

(57) ABSTRACT

A water resistant/proof speaker module with improved performance and bass reflection is provided. The speaker module comprises a housing into which an audio unit fits. The speaker module is provide with a speaker face having at least 50% of the speaker face open to improve audio characteristics. Seals are provided along the speaker module to inhibit moisture from entering the device housing.

### CLAIM OF PRIORITY UNDER 35 U.S.C. §119

None.

### CLAIM OF PRIORITY UNDER 35 U.S.C. §120

None.

### REFERENCE TO CO-PENDING APPLICATIONS FOR PATENT

None.

### BACKGROUND

1. Field

The present relates generally to audio modules, and more specifically to water resistant or water proof audio modules for wireless devices.

2. Background

Telephony and other wireless equipment is frequently used in a hands free environment. To accomplish this, many devices incorporate a microphone and a speaker into the telephony device. For example, many wireless handsets incorporate a speaker in the housing of the handset.

Because telephony and other wireless equipment are become more and more ubiquitous, there has arisen a need to provide equipment that operates in less than ideal environments for electronic devices. The equipment may be used, for example, in hazardous environments, moisture leaden environments, or other less than suitable conditions. Using cellular telephones in a rainy environment is one particularly common example today.

Many devices feature or include a water proof or water resistant housing to facilitate the use of telephones and other wireless equipment in less than suitable operating conditions. Many of these devices build a speaker directly into the device housing and seal the device using either an adhesive or single gasket. While potentially water resistant, building the speaker directly into the housing may have other consequences, such as, reduced audio performance, difficult manufacturing, costly, or the like. Moreover, many of these devices become less effective in the event of a single failure of the water bearer. For example, water may penetrate the device on a gasket failure or defect. Alternatively, an adhesive may separate causing a leak path.

Thus, it would be desirous to provide a speaker/audio device that address at least some of the above described concerns.

### SUMMARY

Embodiments disclosed herein address the above stated needs by providing a speaker module for an electronic device. The speaker module comprising a housing with a base, a top edge opposite the base, at least one sidewall extending from the base to the top edge, and an intermediate shoulder extending radially inward from the at least one sidewall between the base and the top edge. An electrical conduit resides in the sidewall. An audio unit comprising an audio unit base, an audio unit top edge opposite the audio unit base, and an audio unit sidewall fits in the housing such that the audio unit base is supported by the intermediate shoulder and the audio unit sidewall is in sliding relation to the at least one sidewall. A first seal resides between the audio unit base and the intermediate shoulder to provide at least a water resistant seal. A second seal is aligned with the audio unit top edge. A speaker face aligned with the top edge and a third seal, such that the speaker module is made water resistant.

The foregoing and other features, utilities, and advantages of the technology of the present application will be apparent from the following more particular description of the technology of the present application that is illustrated by the accompanying drawings.

### BRIEF DESCRIPTION OF THE DRAWINGS

FIG. 1 is a perspective view of an electronic device having a speaker compartment;

FIG. 2 is a perspective view of a speaker module;

FIGS. 3, 4, 6, and 7 are perspective, partially exploded views of the speaker module of FIG. 2;

FIG. 5 is a cross sectional view of an exemplary seal;

FIG. 8 is a perspective view of the speaker module heatstaked; and

FIG. 9 is a cross section view of another speaker face.

### DETAILED DESCRIPTION

The technology of the present application will now be described with reference to the figures. While the technology of the present application will be described with particular reference to an audio module insertable into the backplane of a wireless device, one of ordinary skill in the art will recognize the audio module could be insertable into any portion of the housing and would be usable with any device providing a speaker or similar audio module. Moreover, the word “exemplary” is used herein to mean “serving as an example, instance, or illustration.” Any embodiment described herein as “exemplary” is not necessarily to be construed as preferred or advantageous over other embodiments. Moreover, unless specifically identified, all embodiments described herein should be considered exemplary embodiments of the technology.

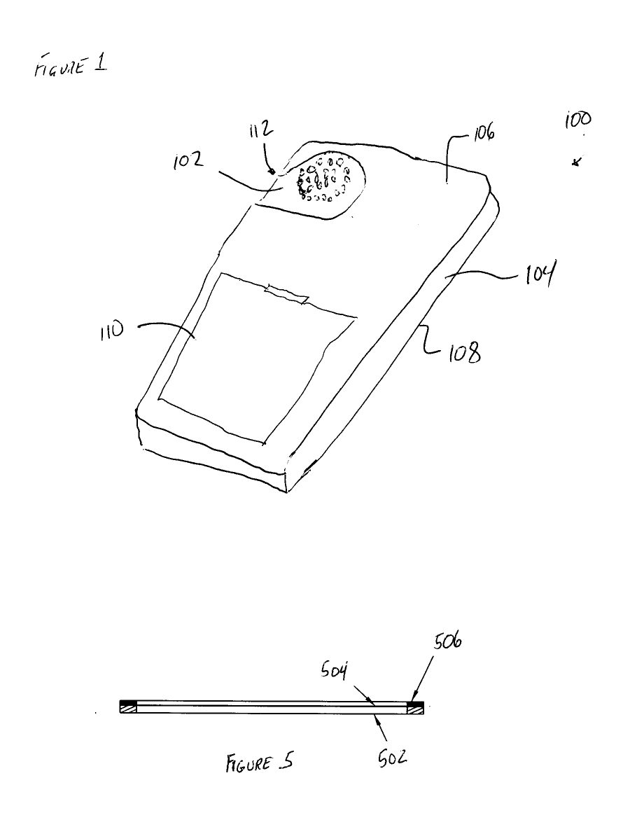

Referring first to FIG. 1, a perspective view of a device 100 having a speaker 102 is shown. Device 100 is shown as a portable device, but device 100 does not need to be portable. Moreover, device 100 may be a cellular telephone, a two-way radio, a combination thereof, an MP-3 player, a portable digital assistant, a Blackberry mounted telephony equipment, mounted speaker units, other telecommunications equipment or the like. Device 100 is shown as having a housing 104 with a back panel 106 and a front panel 108. Back panel 106 further contains a battery compartment 110. Speaker 102 is a separate module that fits into a speaker compartment 112 in back panel 106. As shown, speaker compartment 112 can be countersunk such that speaker 102 is flush or recessed with respect to back panel 106 as shown or not countersunk such that speaker 102 is raised from back panel 106. Moreover, while shown as associated with back panel 106, speaker 102 could be placed on anywhere on housing 104 with sufficient surface area.

Referring now to FIG. 2, a speaker module 200 is shown that fits in speaker compartment 112. Speaker module 200 could be connected or coupled to speaker compartment 112 using any number of conventional connection mechanisms including welding, adhesives, rivets, screws, press-fit, snap rings, or the like. As shown, speaker module 200 has a plurality of protrusions 202 extending from a housing 204. Protrusions 202 have bores 206. Pins, rivets, or the like (not specifically shown) can be sued to couple speaker module 200 to speaker compartment 112. Housing 204 can be any number of shapes and is generally defined by the requirements of the manufacturer of device 100. However, typically speaker modules are circular in shape.

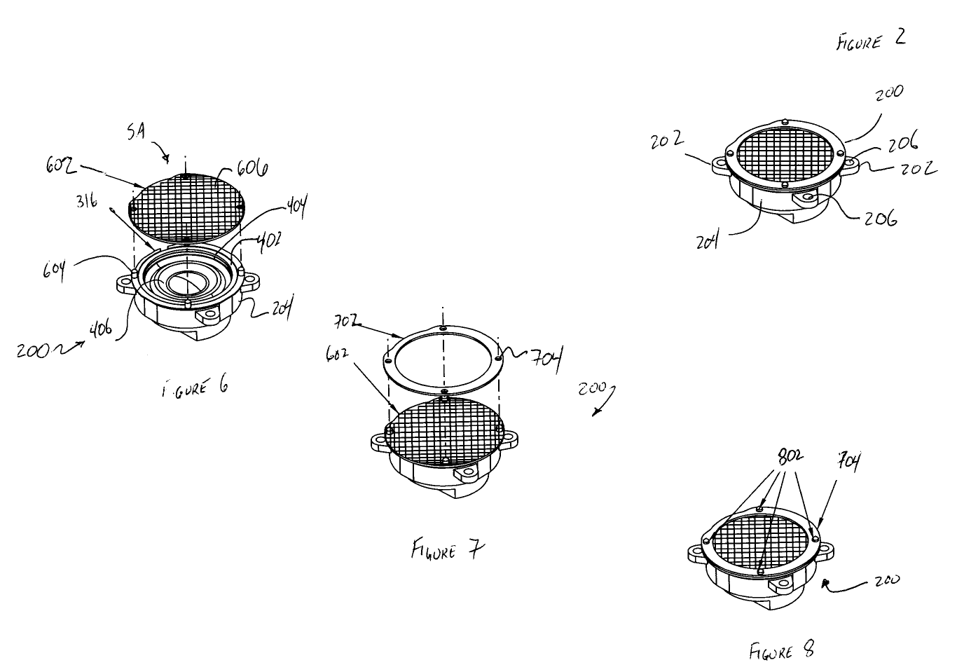

Referring now to FIGS. 3-8, speaker module 200 is described in more detail. Referring first to FIG. 3, a perspective, exploded view of housing 204 and audio unit 302 is provided. Audio unit 302 is any conventional unit and will only be described as it relates to the present technology. Housing 204 comprises a base 306, which would be internal to housing 104 and speaker compartment 112. Extending from base 306 toward back panel 106 of housing 104 is a lower sidewall 308. Lower sidewall 308 terminates at a intermediate shoulder 310. Base 306 and lower sidewall 308 define a first recess 312. Intermediate shoulder 310 extends radially outward from lower sidewall 308. Upper sidewall 314 extends from intermediate shoulder 310 to a top edge 316 of housing 204, which in the embodiment shown in FIG. 1 would be slightly recessed from back panel 106. Alternatively to considering intermediate shoulder 310 as extending radially outward from lower sidewall 308, shoulder 310 may be considered as extending laterally inward from upper sidewall 314. Protrusions 202 extend radially outward from upper sidewall 314. Intermediate shoulder 310 and upper sidewall 314 define a second recess 318. Second recess is sized to fit audio unit 302. Audio unit 302 has an audio unit base 322 and audio unit sidewalls 324. Audio unit base 302 rests on shoulder 310 and sidewalls 324 are slidably engaged with upper sidewalls 314. Upper sidewall 314 further includes at least one electrical conduit 326, which is shown as a channel extending from shoulder 310 to top edge 316 in upper sidewalls 314. Electrical cables (not shown) would electrically connect audio unit 302 to device 100.

A first seal 328 resides between shoulder 310 and audio unit base 322. First seal 328 provides a water resistant or water proof barrier to the internals of device 100 via the speaker module 200. First seal 328 may be any number of conventional seals, such as, for example, a gasket, an o-ring, a silicone epoxy, an adhesive, or the like. First seal 328 also should seal electrical conduit 326. For example, a silicone epoxy may wick around the various electrical cables or a watertight strain relief can form a seal.

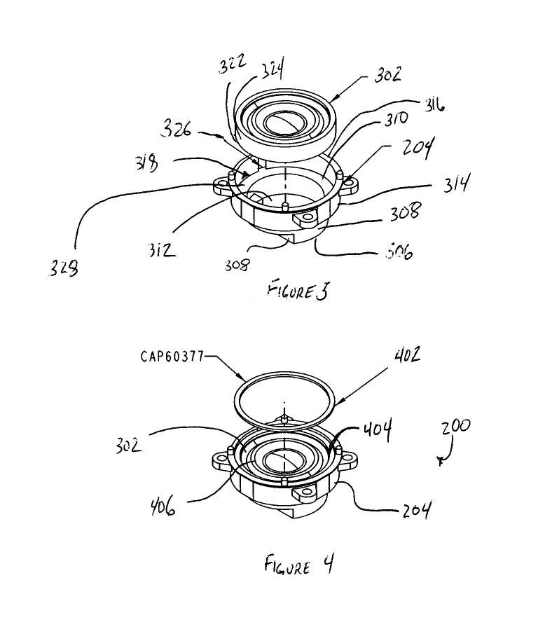

Referring now to FIG. 4, speaker module 200 is shown partially exploded after audio unit 302 is fitted into second recess 318. A second seal 402 is provided. Second seal 402 is aligned with an audio unit top edge 404. Second seal 402 provides a second water resistant or water proof barrier to the internals of device 100 via the speaker module 200. Second seal 402 may be any number of seals, such as, for example, a gasket, an o-ring, a silicone epoxy, an adhesive, or the like. FIG. 5 provides a cross-sectional view of one embodiment of second seal 402 that works well. Second seal 402 in this embodiment encompasses a audio facing gasket 502, a cloth mesh 504, and a speaker face facing gasket 506. Audio facing gasket 502 may be a double sided adhesive gasket to bond to audio unit top edge 404 and cloth mesh 504. Speaker face facing gasket 506 also may be a double sided adhesive gasket to bond to cloth mesh 504 and a speaker face, which will be explained further below. Cloth mesh typically provides a dust cover for audio unit 302. Moreover, audio unit 302 is provided with a top face 406 that is itself water proof or water resistant.

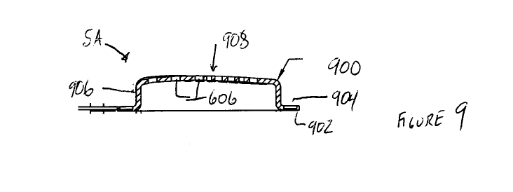

Referring now to FIGS. 6, 7, and 8, speaker module 200 is shown partially exploded in FIGS. 6 and 7 after second seal 402 is provided and assembled in FIG. 8. First, speaker face 602 is aligned with alignment protrusions 604 extending from top edge 316. Speaker face 602 would couple to speaker face facing gasket 506. Speaker face 602 may be formed of a plastic, composite, or metal material having opening 606. A surface area SA of speaker face 602 should have a sufficient number of opening 606 to provide satisfactory audio performance. It has been found having 50% or more of surface area SA to comprise openings provides satisfactory audio performance. Referring to FIG. 7, a third seal 702 is provided. Third seal 702 may be any type of sealant previously mentioned, but is shown as a gasket. Third seal 702 has alignment bores 704. Alignment bores align with alignment protrusions 604. Ideally, after aligning and placing third seal 702, compressive force would be applied and the unit locked or clamped under compression to increase the effectiveness of one or more of the seals. For example, alignment protrusions, may comprise a thermoset material that may act as a heatstake 802 to retain the compression.

Referring now to FIG. 9, a speaker grill 900 is provided as an alternative to flat speaker face 602. Speaker grill 900 comprises a flanged surface 902 that extends under third seal 702 and may be heatstaked using heatstakes 802 as provided in FIG. 8. Speaker grill 900, however, includes a raised grill wall 904 extending away from audio module 302 and a grill face 906. Grill face 906 would have surface area SA with openings 606 similar to speaker face 602, ideally with over 50% of surface area SA being open.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A speaker module for an electronic device, comprising:
a housing, the housing a base, a top edge opposite the base, at least one sidewall extending from the base to the top edge, and an intermediate shoulder extending radially inward from the at least one sidewall between the base and the top edge;
at least one electrical conduit residing in the at least one sidewall;
an audio unit, the audio unit comprising an audio unit base, an audio unit top edge opposite the audio unit base, and an audio unit sidewall, the audio unit fitting in the housing such that the audio unit base is supported by the intermediate shoulder and the audio unit sidewall is in sliding relation to the at least one sidewall;
a first seal residing between the audio unit base and the intermediate shoulder to provide at least a water resistant seal;
a second seal aligned with the audio unit top edge;
a speaker face aligned with the top edge; and
a third seal aligned with the top edge, such that the speaker module is made water resistant.

2. The speaker module of claim 1, wherein the first seal comprises a gasket.

3. The speaker module of claim 1, wherein the first seal comprises an epoxy.

4. The speaker module of claim 1, wherein the second seal comprises:
an audio facing gasket;
a cloth mesh; and
a speaker face facing gasket.

5. The speaker module of claim 4, wherein the audio facing gasket and the speaker face facing gasket are double sided adhesive gaskets.

6. The speaker module of claim 1, further comprising alignment detent in the top edge and wherein the third seal further comprises a gasket with alignment protrusions that fit in the alignment detent.

7. The speaker module of claim 6, wherein the alignment protrusions comprise a thermoset resin forming a heatstake coupling the third seal to the speaker face.

8. The speaker module of claim 1, wherein the speaker face comprises a surface area such that at least more than 50% of the surface area comprises openings.

9. The speaker module of claim 1, wherein the speaker face comprises a mesh material.

10. The speaker module of claim 1, wherein the speaker face comprises a stamped metal material.

11. The speaker module of claim 1, wherein the first seal comprises an adhesive.

12. The speaker module of claim 1, wherein the at least one sidewall comprises a lower sidewall extending from the base to the intermediate shoulders and an upper sidewall extending from the intermediate shoulders to the top edge.

13. The speaker of claim 12, wherein the base and the lower sidewall define a first recess and the intermediate shoulders and the upper sidewalls define a second recess.

14. A wireless device having a separate speaker module, the wireless device comprising:
a wireless device housing, the wireless device housing having a speaker compartment;
a speaker module, the speaker module sided to fit in the speaker compartment, the speaker module comprising:
a housing, the housing a base, a top edge opposite the base, at least one sidewall extending from the base to the top edge, and an intermediate shoulder extending radially inward from the at least one sidewall between the base and the top edge;
at least one electrical conduit residing in the at least one sidewall;
an audio unit, the audio unit comprising an audio unit base, an audio unit top edge opposite the audio unit base, and an audio unit sidewall, the audio unit fitting in the housing such that the audio unit base is supported by the intermediate shoulder and the audio unit sidewall is in sliding relation to the at least one sidewall;
a first seal residing between the audio unit base and the intermediate shoulder to provide at least a water resistant seal;
a second seal aligned with the audio unit top edge to provide at least a water resistant seal;
a speaker face aligned with the top edge; and
a third seal aligned with the top edge to provide at least a water resistant seal, such that the speaker module is made water resistant.

15. The wireless device of claim 14, further comprising an electrical connection extending from the audio unit to the wireless device through the electrical conduit.

16. The wireless device of claim 14, wherein the wireless device is selected from a group of wireless device consisting of: a cellular telephone, a two-way radio, a portable digital assistant, an electronic game, or a MP-3 player.

17. A speaker module for an electronic device, comprising:
a housing, the housing a base, a top edge opposite the base, at least one sidewall extending from the base to the top edge, and an intermediate shoulder extending radially inward from the at least one sidewall between the base and the top edge;
at least one electrical conduit residing in the at least one sidewall;
an audio unit, the audio unit comprising an audio unit base, an audio unit top edge opposite the audio unit base, and an audio unit sidewall, the audio unit fitting in the housing such that the audio unit base is supported by the intermediate shoulder and the audio unit sidewall is in sliding relation to the at least one sidewall;
first means for sealing between the audio unit base and the intermediate shoulder to provide at least a water resistant seal;
second means for sealing located at the audio unit top edge;
a speaker face aligned with the top edge; and
third means for sealing aligned with the top edge, such that the speaker module is made water resistant.

18. The speaker module of claim 17, coupled to an electronic device selected from the group of electronic devices consisting of: a cellular telephone, a two-way radio, an MP-3 player, a portable digital assistant, a mounted telephone, mounted speaker unit, a handheld computer, a desktop computer, or a laptop computer.

19. The speaker module of claim 17, wherein the first means for sealing is selected from the group consisting of: a gasket, an epoxy, a gel, or an adhesive.

20. The speaker module of claim 17, wherein the second means for sealing comprises an audio module facing gasket, a cloth mesh, and a speaker face facing gasket.

21. The speaker module of claim 17, wherein the third means for sealing comprises a gasket.

22. The speaker module of claim 1, wherein the speaker face comprises:
a flanged surface;
a raised speaker grill wall extending away from the audio unit; and
a grill face.
